(19) United States
(12) Patent Application Publication
(10) Pub. No.: US 2024/0193241 A1
(43) Pub. Date: Jun. 13, 2024

(54) RAISEABLE PROFILE-BASED ACCESS FOR MEDIA CONTENT

(71) Applicant: Western Digital Technologies, Inc., San Jose, CA (US)

(72) Inventors: Arun Kumar Shukla, Bangalore (IN); Ramanathan Muthiah, Bangalore (IN)

(21) Appl. No.: 18/446,442

(22) Filed: Aug. 8, 2023

Related U.S. Application Data
(60) Provisional application No. 63/432,051, filed on Dec. 12, 2022.

(51) Int. Cl. G06F 21/32; G06F 21/62

(52) U.S. Cl. CPC G06F 21/32; G06F 21/6218

(57) ABSTRACT

A media playback device is configured to control access to a plurality of files. The media playback device includes memory configured to store a plurality of files, the plurality of files including at least a first set of files and a second set of files, the second set of files having a higher security level the first set of files. The media playback device also includes control circuitry that can be configured to receive a first login from a user, determine that the first login is associated with a user profile associated with the first set of files and the second set of files, provide access to the first set of files in response to validating the first login while keeping the second set of files locked, receive a second login, and provide access to the second set of files in response to validating the second login.

### CROSS-REFERENCE TO RELATED APPLICATIONS

The present application claims priority to U.S. Provisional Patent Application Ser. No. 63/432,051, filed Dec. 12, 2022, entitled RAISEABLE PROFILE-BASED ACCESS FOR MEDIA CONTENT, the disclosure of which is hereby incorporated by reference in its entirety.

### BACKGROUND

### Field

This disclosure relates to access control for media devices. More particularly, the disclosure relates to devices and methods for profile-based access for media content stored on media devices.

### Description of Related Art

Media storage devices typically store various types of media, such as music, videos, and applications. Some media may be appropriate for all ages, while others are only appropriate for teens or adults. Various types of access control can control access to these media based on a particular user.

### BRIEF DESCRIPTION OF THE DRAWINGS

Various embodiments are depicted in the accompanying drawings for illustrative purposes, and should in no way be interpreted as limiting the scope of this disclosure. In addition, various features of different disclosed embodiments can be combined to form additional embodiments, which are part of this disclosure.

FIGS. 1A-1C are diagrams illustrating a media playback device that is configured to provide profile-based access to the device and media stored on the device, according to certain embodiments.

FIG. 2 illustrates a block diagram representing a login process performed by the media playback device, according to certain embodiments.

FIG. 3 illustrates a block diagram representing an access control setup process performed by the media playback device, according to certain embodiments.

FIG. 4 illustrates example details of the media playback device, according to certain embodiments.

### DETAILED DESCRIPTION

While certain embodiments are described, these embodiments are presented by way of example only, and are not intended to limit the scope of protection. Indeed, the novel methods and systems described herein may be embodied in a variety of other forms. Furthermore, various omissions, substitutions and changes in the form of the methods and systems described herein may be made without departing from the scope of protection.

### Overview

User security is a concern today for manufacturers of media playback devices. User security can be implemented on the device side, as well as supplemented through access controls on content. Many of the leading content providers have restriction on content, for example, with limitations based on age groups. For example, video on media streaming platform can come with age restrictions, with some content having universal access, and some content accessible only for specific age groups, such as 6+ years old, 13+ years old, 18+ years old, or the like.

Media playback devices can utilize different user logins to control access to the content on the same device. For example, a parent may use a first login, while a child can use a second login. Depending on which account (e.g., parent or child) logs in, different media content may be accessible. However, many children use their parents' phone or other media playback device. When the child start using the phone's mobile applications (“app”) like YouTube etc., the child has access to the parents' account for that app as the default. In this scenario, using a simple login-based approach makes it difficult to control the content on the device as logging in with the parent's account to the device generally also provides parental-level access to the media content, including apps, that are on the device. The following describes devices and methods that can prevent the playback of age-inappropriate content when children use the parents' login, either intentionally or unintentionally, by using raisable logins to access devices and content.

### Media Playback Device

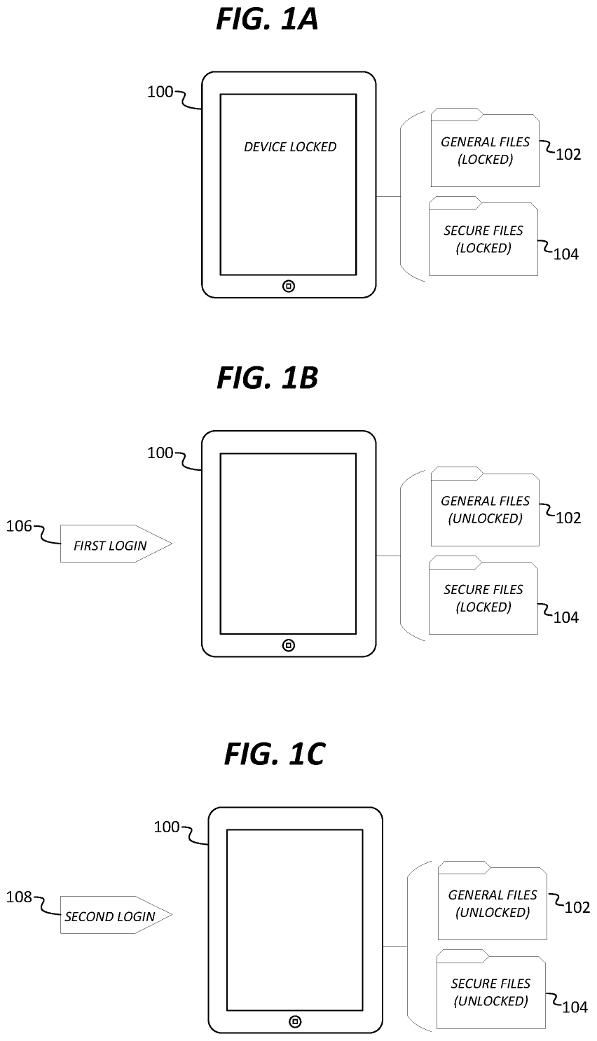

FIGS. 1A-1C are diagrams illustrating a media playback device 100 that is configured to provide profile-based access to the device and media stored on the device, according to certain embodiments. The media playback device 100 may be a phone, tablet, laptop, computer, or other type of device for playing back media and running applications. In FIG. 1A, the media playback device 100 starts in a locked configuration, where the media playback device 100 is generally unusable except for possibly some basic functionality, such as providing time, notifications, or emergency calling service. For example, the device 100 may show a lock screen or be in a low power mode. Stored on the device 100 may be files with different security or access levels. In one implementation, files are categorized into general files 102 and secure files 104. Other implementations may use more than two categories to corresponding to different security levels for the files. While the device 100 is locked, both the general files 102 and the secure files are locked.

Locked files may be implemented in a few different ways. For example, locked files may be inexecutable or unopenable, such that a user cannot open an application or view the contents of the file. Locked files may also be encrypted, such that the contents cannot be read by the device 100 until the appropriate decryption key is used. Locked files may also be hidden, so that they are not viewable unless the authorized account is logged in. Furthermore, the above implementations for locked files may be combined in various combinations for greater security.

In FIG. 1B, the user provides first login 106 to the media playback device 100, which then validates the first login. If the login matches the login associated with an account on the device 100, the device unlocks. With the validated first login 106, the general files 102 associated with the account become unlocked, while the secure files 104 associated with the account remain locked. The user can then access the general files 102, but cannot access the secure files 104 without raising their access privilege by providing additional authentication.

In some implementations, when a user tries to open one of locked the secure files 104, the media playback device 100 requests a second login 108. The second login 108 may be a more secure type of login than the first login 106. For example, the first login 106 may be a password or a pin, while the second login 108 requires a biometric identifier (e.g., facial recognition, fingerprint, or the like) or a two-factor authentication using a secondary device. In some implementations, the second type of login may be the same type as the first login, but of greater complexity, such as a longer password or larger pattern.

In one example scenario, a parent unlocks their smart phone by providing the first login 106 and gives the smart phone (or other media playback device 100) to their child. The child can then view videos or run applications that are categorized as general files 102 that are unlocked after the first login 106. However, if the child tries to open one of the secure files 104, the smart phone requests the second login 108. As the child should not have the second login 108, the child will not be able to access the secure file. For example, the parent may have designated certain video streaming apps, certain social media apps, or financial-related apps as secure files 104 that the child cannot access, while game apps or child-appropriate streaming apps may have been designated as general files 102.

In FIG. 1C, the media playback device 100 requests and obtains the second login 108 from the user. The media playback device 100 then validates the second login 108. If the received login matches the second login associated with the account on the device 100, the device can unlock the remaining locked files. With the validated second login 108, the general files 102 associated with the account remain unlocked, while the secure files 104 associated with the account also account become unlocked. The user can then access both the general files 102 and the secure files 104.

When obtaining the second login 108, the media playback device 100 may, optionally, start a biometric capture device to obtain biometric data from the user. For example, the media playback device 100 may activate a camera or fingerprint reader and may then provide a notification to the user directing the user to provide the biometric data (e.g., request user to place fingerprint on sensor, request user to look at camera, etc.).

As will be apparent, the above implementation can be extended to have additional levels of security. For example, rather than dividing into two categories of files, the files could be categorized into three categories, such as general files, medium security files, and high security files. The first login gets access to the general files, the second login gets access to medium security files, and the third login gets access to the high security files. In addition, the above could be further extended into four or more categories of files.

In addition, different user profiles may have different levels of security. For example, a first user profile may use a two-level file security system as described in FIGS. 1A-1C. Meanwhile, a second user profile where the user desires higher security levels may use a three-level file security system. Meanwhile, a third user profile that does not require additional security may just have a single access level with a just a single login used. As the media playback device 100 can support multiple user profiles, these different file security levels can co-exist on the same device.

Furthermore, different user profiles may be associated with different sets of files. When logging in with one of the logins associated with a particular account, the user only gains access to the files associated with that particular account. Files associated with other accounts can remain locked or hidden. Thus, even raising the access level of an account does not necessarily allow the account to see all the files on the media playback device 100.

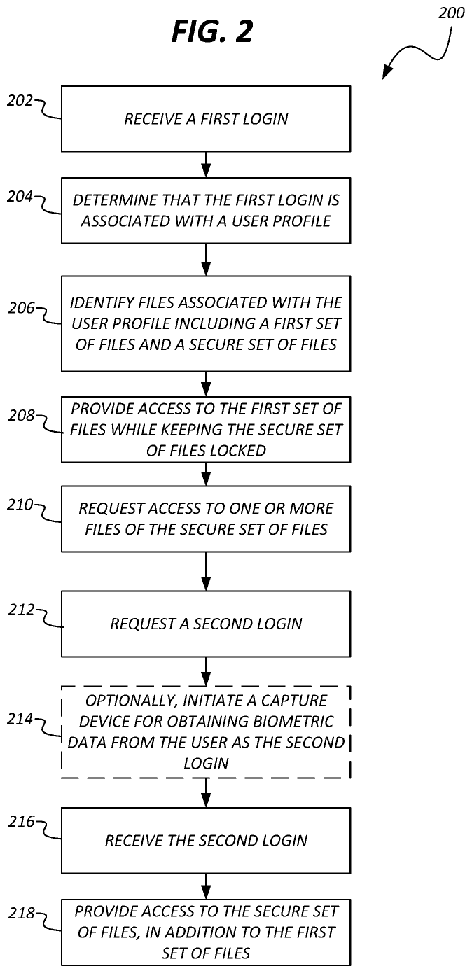

FIG. 2 illustrates a block diagram representing a login process 200 performed by a media play back device 100, according to certain embodiments. For ease of reference, the following discusses the login process in reference to the media playback device 100 of FIGS. 1A-1C, though it can work with other types of electronic devices that implement a user login system. Furthermore, the process may be performed by the media playback device 100 or one of its components, such as its control circuitry.

At block 202, the media playback device 100 receives a first login. For example, the first login may be a password or pass code. In some implementations, the media playback device 100 displays a lock screen or login screen that prompts the user to enter the first login. The user may also select an account in cases where multiple accounts exist on the media playback device 100.

At block 204, the media playback device 100 determines that the first login is associated with a user profile. The user profile may be provided by the user from a selection of available accounts or by providing an account name with the password. The media playback device 100 can then validate the first login by determining if the first login matches a saved login associated with the user profile. Matching may be done by direct comparison or by deriving a unique identifier and comparing to a stored identifier. For example, the media playback device 100 may generate and compare hashes to validate the login. This enables logins to not be directly stored on the media playback device 100, enhancing the security of its data.

At block 206, the media playback device 100 identifies files associated with the user profile, including a first set of files (also called general files) and a secure set of files. Different accounts may have access to different sets of files located on the media playback device 100. For example, a first user may have access to files 1-50, while a second user has access to files 51-100. The first user may further subdivide files 1-50 into the general files (e.g., files 1-25) and the secure set of files (e.g., files 26-50). This scenario is expressed by Table 1 below.

TABLE 1

File Identifier

| Users | General | Secure |
|---|---|---|
| First User | 001-025 | 025-050 |
| Second User | 051-075 | 076-100 |
| Third User | 101-120 | 121-130 |

At block 208, the media playback device 100 provides access to the first set of files while keeping the secure set of files locked. In the above example scenario, the first user putting in the first login would get access to files 1-25, while files 26-50 stay locked.

At block 210, the media playback device 100 requests access to one or more files of the secure set of files. Going back to the example scenario, if the first user tries to access file 26, which is part of the secure set of files, the media playback device 100 can determine that file 26 is currently locked and does not immediately provide access.

At block 212, the media playback device 100 requests a second login. As the secure set of files are locked, the media playback device 100 proceeds with a second authentication step to unlock the secure set of files.

At block 214, the media playback device 100 optionally initiates a capture device for obtaining biometric data from the user as the second login. The capture device may be a camera, fingerprint sensor, voice recorder, or the like. Using biometric data can provide better security, particularly in the parent/child scenario. As a child using the device would not be able provide the parent's biometric data without the parent's active participation, the child would not be able to access the secure files inadvertently. However, the media playback device 100 does not necessarily need to use biometric data for the second login. For example, the second login may be a password/passcode different from the first login. The media playback device 100 may require that the password/passcode be of greater complexity than the first login.

At block 216, the media playback device 100 receives the second login. The media playback device 100 can then determine if the second login matches the higher-level login associated with the user profile. Assuming the second login is verified, the process proceeds to block 216. If the second login is not verified, the media playback device 100 may re-request the second login or simply keep the secure files locked.

At block 218, assuming the second login is validated, the media playback device 100 provides access to the secure set of files. As a result, the user is provided with access to both the secure set of files and the previously accessible first set of files. Going back to the example scenario, the first user already had access to files 1-25 and also gains access to files 26-50 as a result of providing the second login. The process 200 can then end.

As will be apparent, the process 200 can be extended to enable multiple levels of security. For example, the process 200 can be extended to include a third login, a fourth login, etc. Higher levels of logins can provide access to increasingly greater amounts of files associated with the user profile.

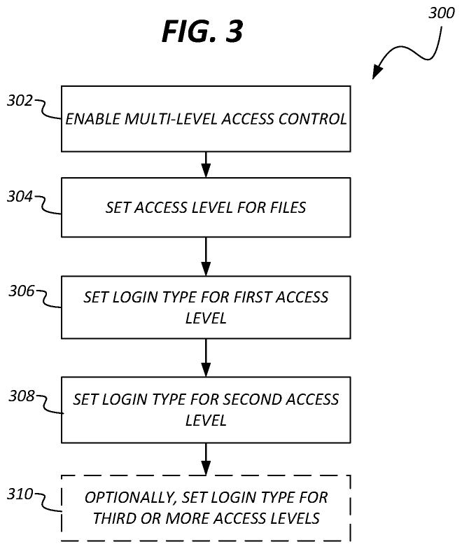

FIG. 3 illustrates a block diagram representing an access control setup process 300 performed by a media playback device 100, according to certain embodiments. For ease of reference, the following discusses the login process in reference to the media playback device 100 of FIGS. 1A-1C, though it can work with other types of electronic devices that implement a user login system. Furthermore, the process may be performed the media playback device 100 or one of its components, such as its control circuitry.

At block 302, the media playback device 100 enables multi-level access control. In one scenario, an administrative user accesses the administrative functions of the media playback device 100 and configures the settings for multi-level access control. There may also be default values for the settings that are set by the device manufacturer or operating system.

At block 304, the media playback device 100 sets access levels for the files. In one scenario, the user is provided options, via a display or other interface, to select the access level setting for the device. The administrative user may be able to select two levels, three levels, or even more security levels. For example, the user may select a two-level system that categorizes files into general files and secure files, as discussed in earlier figures. Alternatively, the administrative user may select three levels, including a general set of files, a mid-level security set of files, and a high-level security set of files.

At block 306, the media playback device 100 sets a login type for a first access level. The administrative user can set the first login type as passwords, numerical or pattern passcodes, security questions, facial recognition, voice commands, fingerprints, other biometric data, or the like. As the first access level is for general files (or otherwise the lowest security level for files), the login type may be something easier to input and/or remember as strong security is not necessary. For example, the administrative user may enable the first login type to be pattern passcodes or pin numbers.

At block 308, the media playback device 100 sets a login type for a second access level. The administrative user can set the second login type as passwords, numerical or pattern passcodes, security questions, facial recognition, voice commands, fingerprints, other biometric data, or the like. As the second access level is for secure files, the second login type may be set to something harder to figure out or enter by someone who is not the account owner. For example, the administrative user may set the second login type as biometric data.

At block 310, the media playback device 100 can optionally set a login type for a third or more access level. The administrative user can set the third login type as passwords, numerical or pattern passcodes, security questions, facial recognition, voice commands, fingerprints, other biometric data, or the like. As the third access level is for higher security files, the third login type may be set to something with higher security, such as two-factor authentication. For example, the administrative user may require a smart phone, hardware security key, or other device to be involved in the login process in order to enable two-factor authentication, obtain a one-time password, and/or provide an application-based approval from the other device (e.g., using a mobile application).

### Example Media Playback Device

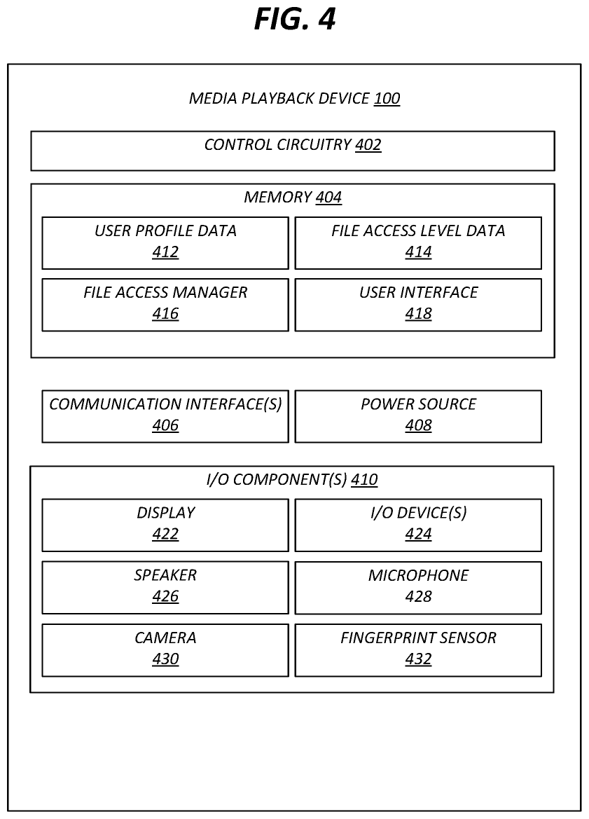

FIG. 4 illustrates example details of the media playback device 100 in accordance with one or more embodiments. As illustrated, the media playback device 100 can include one or more of the following components, devices, modules, and/or units (referred to herein as “components”), either separately/individually and/or in combination/collectively: control circuitry 402, data storage/memory 404, one or more communication interfaces 406, a power source 408 (e.g., battery or power supply unit), and/or one or more I/O components 410. In some embodiments, the media playback device 100 can comprise a housing/enclosure configured and/or dimensioned to house or contain at least part of one or more of the components of the media playback device 100.

Although certain components of the media playback device 100 are illustrated in FIG. 4, it should be understood that additional components not shown can be included in embodiments in accordance with the present disclosure. Furthermore, certain of the illustrated components can be omitted in some embodiments. Although the control circuitry 402 is illustrated as a separate component in the diagram of FIG. 4, it should be understood that any or all of the remaining components of the media playback device 100 can be embodied at least in part in the control circuitry 402. That is, the control circuitry 402 can include various devices (active and/or passive), semiconductor materials and/or areas, layers, regions, and/or portions thereof, conductors, leads, vias, connections, and/or the like, wherein one or more of the other components of the media playback device 100 and/or portion(s) thereof can be formed and/or embodied at least in part in/by such circuitry components/devices.

The various components of the media playback device 100 can be electrically and/or communicatively coupled using certain connectivity circuitry/devices/features, which can or may not be part of the control circuitry 402. For example, the connectivity feature(s) can include one or more printed circuit boards configured to facilitate mounting and/or interconnectivity of at least some of the various components/circuitry of the media playback device 100. In some embodiments, two or more of the control circuitry 402, the data storage/memory 404, the communication interface(s) 406, the power source 408, and/or the input/output (I/O) component(s) 410, can be electrically and/or communicatively coupled to each other.

The data storage/memory 404 can employ a variety of storage technologies and/or form factors and can include various types of data storage devices (DSDs). For example, the data storage may be a solid-state drive (SSD), Secure Digital (SD) card, or a universal serial bus (USB) memory stick that uses semiconductor memory as the storage media. In other implementations, the data storage may be a hard disk drive (HDD) that uses magnetic disks as the storage media or a solid-state hybrid drive (SSHD) that uses a combination of semiconductor memory and magnetic disk technology.

The data storage/memory 404 can utilize various types of non-volatile memory (NVM) to permanently store data. NVM is a type of computer memory that can retain stored information even after power is removed. For example, the data storage/memory 404 can include one or more magnetic disks and/or semiconductor memory. The semiconductor memory can include any of various memory technologies, such as NAND memory and its variations like SLC (Single Level Cell), eMLC (Enterprise Multi Level Cell), MLC (Multi Level Cell), TLC (Triple Level Cell), and QLC (Quadruple Level Cell). New types of emerging non-volatile memory could also be used such as Program in Place or Storage Class Memory (SCM) such as ReRam, Phase-Change Memory (PCM), and Magnetoresistive Random-Access Memory (MRAM).

As illustrated, the memory 404 can include user profile data 412, file access level data 414, a file access manager 416 and a user interface 418 configured to facilitate various functionality discussed herein. The user profile data 412 may be obtained from a networked server, such as a cloud service or stored locally on the media playback device 100. The user profile data 412 can include profile information for each user of the media playback device 100. The user profile data 412 can also include login types settings for different access levels and login data associated for each profile. The login data may be stored in an encrypted format. In some implementations, the login data is stored in the cloud service and the logins provided by the user are sent to the cloud service. The cloud service can then verify the provided logins with the stored logins associated with the user. By storing the logins only in the cloud service, the media playback device 100 can be harder to hack into as someone with access to the media playback device 100 does not have access to the login data that is not stored on the device.

Meanwhile, the file access level data 414 can include a mapping of user profiles to files and the access levels for those files, such as shown in Table 1 above. Different users may implement different security levels. For example, a first user may use two logins and categorize files into two security levels while a second user may use three logins and categorize files into three levels.

In some embodiments, the file access manager 416, and/or the user interface 418 can include one or more instructions that are executable by the control circuitry 402 to perform one or more operations. Although many embodiments are discussed in the context of the components 416-418 including one or more instructions that are executable by the control circuitry 402, any of the components 416-418 can be implemented at least in part as one or more hardware logic components, such as one or more application specific integrated circuits (ASIC), one or more field-programmable gate arrays (FPGAs), one or more program-specific standard products (ASSPs), one or more complex programmable logic devices (CPLDs), and/or the like.

The file access manager 416 can be configured to receive inputs from the I/O components 410 and translate them into actions performable by the media playback device 100, such as locking or unlocking the device 100. The user interface 418 can be configured to facilitate obtaining user inputs and logins. For example, the user interface 418 can generate prompts for obtaining logins, notifications that certain files are locked, and/or selection screens for changing settings. The user interface component 418 can also provide user interface data for display to the user.

The one or more communication interfaces 406 can be configured to communicate with one or more device/sensors/systems. For example, the one or more communication interfaces 406 can send/receive data in a wireless and/or wired manner over a network. A network in accordance with embodiments of the present disclosure can include a local area network (LAN), wide area network (WAN) (e.g., the Internet), personal area network (PAN), body area network (BAN), etc. In some embodiments, the one or more communication interfaces 406 can implement a wireless technology such as Bluetooth, Wi-Fi, near field communication (NFC), or the like.

The one or more communication interfaces 406 can be a data interface that includes connectors, cables, and/or protocols for connection, communication, and/or power supply between host devices and the media playback device 100. In some embodiments, a port of the data interface can enable transfer of both data and power to connected devices. In some embodiments, the data interface comprises USB hardware and/or software. Various versions of USB can be used, such as USB 2.x, USB 3.x, or USB 4.x. The data interface can include a physical port for coupling with connectors and cables. Various types of USB ports can be included on the media playback device 100, such as male or female Type A, Type B, Type C, mini, and/or micro connectors. Other data interface standards can also be used, such as external SATA (eSATA), ExpressCard, FireWire (IEEE 1394), and Thunderbolt. The data interface can include a port for connecting with a cable or a corresponding port on the

The power source 408 can be configured to provide/manage power for the media playback device 100. In some embodiments, the power source can include one or more batteries, such as a lithium-based battery, a lead-acid battery, an alkaline battery, and/or another type of battery. That is, the power source 408 can comprise one or more devices and/or circuitry configured to provide a source of power and/or provide power management functionality. Moreover, in some embodiments the power source 408 includes a mains power connector that is configured to couple to an alternating current (AC) or direct current (DC) mains power source.

The one or more I/O components 410 can include a variety of components to receive input and/or provide output. The one or more I/O components 410 can be configured to receive touch, speech, gesture, biometric data, or any other type of input. In examples, the one or more I/O components 410 can be used to provide input regarding control of the device 100, such as opening files, entering logins, plays, and/or changing settings. As shown, the one or more I/O components 410 can include the one or more displays 422 configured to display data. The display 422 can include one or more liquid-crystal displays (LCD), light-emitting diode (LED) displays, organic LED displays, plasma displays, electronic paper displays, and/or any other type(s) of technology. In some embodiments, the display 422 include one or more touchscreens configured to receive input and/or display data. Further, the one or more I/O components 410 can include the one or more input devices 424, which can include a touchscreen, touch pad, controller, mouse, keyboard, wearable device (e.g., optical head-mounted display), virtual or augmented reality device (e.g., head-mounted display), etc. Additionally, the one or more I/O components 410 can include one or more speakers 426 configured to output sounds based on audio signals, one or more microphones 428 configured to receive sounds and generate audio signals, such as voice recognition data, one or more cameras 430 for capturing images, such as user faces, and one or more fingerprint sensors 432 for capturing fingerprint data. Other types of capture devices, particularly for biometric data, may also be included in the media playback device 100.

The raiseable, profile-based access processes describe above can be extended to work with other access control methods. For example, the access processes can be combined with age-based access controls. In some implementations, the camera 430 can be used to gain additional information about the user. For example, the file access manager 416 can trigger the camera 430 to capture an image. The file access manager 416 may activate the camera 430 in response to a user logging in, the user trying to open a secure file, the user picking up and looking the device 100, or the like. The media playback device 100 may then perform imaging processing (e.g., using artificial intelligence (AI) based image recognition algorithms) to determine an inferred age of the user. The processing may be performed on the device 100 or on the cloud service. Based on the inferred age, the device 100 may allow access to some of the files based on age-ratings for content media. Such age-ratings may be obtained from online datastore or database for media content such as games, movies, TV shows and the like.

In one implementation, the captured image may be used to distinguish between children and adults. While inferring an accurate or close to accurate age may be a difficult problem, distinguishing between children and adults can be more easily done. Based on the distinction, the media playback device 100 may bypass the second login (and/or other higher logins). In one scenario, if the current account is for an adult, the current user can provide the first login. When the current user attempts to open a secure file, the media playback device 100 can use the image processing to determine if the current user is an adult or a child. If the current user is determined to be an adult, the media playback device 100 can bypass the second login and provide access to the secure file, under the assumption that the current user is the actual account owner. If the current user is determined to be a child, the media playback device 100 can continue requesting a second login, under the assumption that the current user is not the actual account owner. This bypassing behavior may be a setting that is enabled/disabled by the user. For example, if the expected users of the media playback device 100 are only a parent and their child, the parent is not expecting any other adult to be accessing the device and may prefer to more easily access files while still preventing the child to access inappropriate content. In that situation, bypassing additional logins may not greatly reduce security on the media playback device 100.

In some implementations, user age information, such as the inferred age discussed above, can be used to selectively skip portions of certain types of media content. For example, a video stream may be encoded with age ratings on a scene level. The media playback device 100 can then skip certain scenes in the stream based on the user age. That is, instead of blocking out entire files of media content, only portions of the audio and video streams in the file (which may be a streamed file) can be withheld. The age rating metadata for the scenes may be generated in various ways. For example, there may be an analytics module in the media playback device 100 or an external server that performs machine learning to classifying video or audio units into age-based content.

The term “control circuitry” is used herein according to its broad and ordinary meaning, and can refer to any collection of one or more processors, processing circuitry, processing modules/units, chips, dies (e.g., semiconductor dies including come or more active and/or passive devices and/or connectivity circuitry), microprocessors, micro-controllers, digital signal processors, microcomputers, central processing units, graphics processing units, field programmable gate arrays, programmable logic devices, state machines (e.g., hardware state machines), logic circuitry, analog circuitry, digital circuitry, and/or any device that manipulates signals (analog and/or digital) based on hard coding of the circuitry and/or operational instructions. Control circuitry can further comprise one or more storage devices, which can be embodied in a single memory device, a plurality of memory devices, and/or embedded circuitry of a device. Such data storage can comprise read-only memory, random access memory, volatile memory, non-volatile memory, static memory, dynamic memory, flash memory, cache memory, data storage registers, and/or any device that stores digital information. It should be noted that in embodiments in which control circuitry comprises a hardware state machine (and/or implements a software state machine), analog circuitry, digital circuitry, and/or logic circuitry, data storage device(s)/register(s) storing any associated operational instructions can be embedded within, or external to, the circuitry comprising the state machine, analog circuitry, digital circuitry, and/or logic circuitry.

The term “memory” is used herein according to its broad and ordinary meaning and can refer to any suitable or desirable type of computer-readable media. For example, computer-readable media can include one or more volatile data storage devices, non-volatile data storage devices, removable data storage devices, and/or nonremovable data storage devices implemented using any technology, layout, and/or data structure(s)/protocol, including any suitable or desirable computer-readable instructions, data structures, program modules, or other types of data.

Computer-readable media that can be implemented in accordance with embodiments of the present disclosure includes, but is not limited to, phase change memory, static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device. As used in certain contexts herein, computer-readable media may not generally include communication media, such as modulated data signals and carrier waves. As such, computer-readable media should generally be understood to refer to non-transitory media.

### Additional Embodiments

Those skilled in the art will appreciate that in some embodiments, other types of media playback devices can be implemented while remaining within the scope of the present disclosure. In addition, the actual steps taken in the processes discussed herein may differ from those described or shown in the figures. Depending on the embodiment, certain of the steps described above may be removed, others may be added, and the order may be rearranged.

While certain embodiments have been described, these embodiments have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. The accompanying claims and their equivalents are intended to cover such forms or modifications as would fall within the scope and spirit of the protection. For example, the various components illustrated in the figures may be implemented as software and/or firmware on a processor, application-specific integrated circuit (ASIC), field-programmable gate array (FPGA), or dedicated hardware. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

All of the processes described above may be embodied in, and fully automated via, software code modules executed by one or more general purpose or special purpose computers or processors. The code modules may be stored on any type of computer-readable medium or other computer storage device or collection of storage devices. Some or all of the methods may alternatively be embodied in specialized computer hardware.

What is claimed is:

1. A media playback device comprising:
memory configured to store a plurality of files, the plurality of files including at least a first set of files and a second set of files, the second set of files having a higher security level than the first set of files; and
control circuitry configured to:
receive a first login from a user;
determine that the first login is associated with a user profile associated with the first set of files and the second set of files;
in response to validating the first login, provide access to the first set of files while keeping the second set of files locked;
receive a second login; and
in response to validating the second login, provide access to the second set of files.

2. The media playback device of claim 1, wherein the control circuitry is further configured to request the second login in response to an attempt to open a file in the second set of files.

3. The media playback device of claim 1, wherein the control circuitry is further configured to initiate a capture device for obtaining biometric data from the user as the second login.

4. The media playback device of claim 3, wherein the capture device comprises a camera and the biometric data comprises a facial image.

5. The media playback device of claim 3, wherein the capture device comprises a fingerprint sensor and the biometric data comprises a fingerprint.

6. The media playback device of claim 3, wherein the capture device comprises a microphone and the biometric data comprises a voice data.

7. The media playback device of claim 1, wherein the first login is one of a passcode or a password and the second login comprises biometric data.

8. The media playback device of claim 1, wherein the memory is further configured to store settings define a first login type for the first login and a second login type for the second login, wherein the second login type is more secure than the first login type.

9. The media playback device of claim 1, wherein:
the memory is further configured to store a third set of files with a higher security level than the second set of files; and
the control circuitry is further configured to:
in response to validating the first login and the second login, keep the third set of files locked;
receive a third login; and
in response to validating the third login, provide access to the third set of files.

10. The media playback device of claim 1, wherein the second login is obtained by the user from a different device and then entered into the media playback device.

11. A method for controlling access to a plurality of files, the plurality of files including at least a first set of files and a second set of files, the second set of files having a higher security level the first set of files, the method comprising:
receiving a first login from a user;
determining that the first login is associated with a user profile associated with the first set of files and the second set of files;
in response to validating the first login, providing access to the first set of files while keeping the second set of files locked;
receiving a second login; and
in response to validating the second login, providing access to the second set of files.

12. The method of claim 11, further comprising:
requesting the second login in response to an attempt to open a file in the second set of files.

13. The method of claim 11, further comprising:
initiating a capture device for obtaining biometric data from the user as the second login.

14. The method of claim 13, wherein the capture device comprises a camera and the biometric data comprises a facial image.

15. The method of claim 13, wherein the capture device comprises a fingerprint sensor and the biometric data comprises a fingerprint.

16. The method of claim 13, wherein the capture device comprises a microphone and the biometric data comprises a voice data.

17. The method of claim 13, wherein the first login is one of a passcode or a password and the second login comprises biometric data.

18. The method of claim 13, further comprising:
storing settings defining a first login type for the first login and a second login type for the second login, wherein the second login type is of greater complexity than the first login type.

19. The method of claim 13, further comprising:
in response to validating the first login and the second login, keeping a third set of files locked, the third set of files having a higher security level than the second set of files;
receiving a third login; and
in response to validating the third login, providing access to the third set of files.

20. A media playback device comprising:
means for storing a plurality of files, the plurality of files including at least a first set of files and a second set of files, the second set of files having a higher security level the first set of files; and
control circuitry configured to:
receive a first login from a user;
determine that the first login is associated with a user profile associated with the first set of files and the second set of files;
in response to validating the first login, provide access to the first set of files while keeping the second set of files locked;
receive a second login; and
in response to validating the second login, provide access to the second set of files.
